(19) United States
(12) Patent Application Publication
(10) Pub. No.: US 2025/0383824 A1
(43) Pub. Date: Dec. 18, 2025

(54) ELECTRONIC DEVICE

(71) Applicant: BROTHER KOGYO KABUSHIKI KAISHA, Nagoya (JP)

(72) Inventor: Yasukichi ISODA, Chita (JP)

(73) Assignee: BROTHER KOGYO KABUSHIKI KAISHA, Nagoya (JP)

(21) Appl. No.: 19/236,550

(22) Filed: Jun. 12, 2025

(30) Foreign Application Priority Data
Jun. 13, 2024 (JP) 2024-095905

(51) Int. Cl. G06F 3/12

(52) U.S. Cl. CPC G06F 3/1221; G06F 3/1229

(57) ABSTRACT

An electronic device is configured to receive supply of power from a power supply device. The electronic device includes: a controller; and a connection interface configured to be connected to a power consuming device. The controller is configured to receive supply of first power from the power supply device in accordance with a standard related to supply of power through a communication cable, and then perform power negotiation for requesting the power supply device to supply second power different from the first power. Before requesting the power supply device to supply the second power in the power negotiation, the controller is configured to acquire a supply condition of power required by the power consuming device connected to the connection interface, and determine the second power based on the acquired supply condition.

### REFERENCE TO RELATED APPLICATIONS

This application claims priority from Japanese Patent Application No. 2024-095905 filed on Jun. 13, 2024. The entire content of the priority application is incorporated herein by reference.

### BACKGROUND ART

The present disclosure relates to an electronic device, and more particularly relates to an electronic device to which a power consuming device can be connected.

A universal serial bus power delivery (USB PD) standard is known as a standard related to supply of power through a communication cable. For example, there is a printer that performs power negotiation with a power source in accordance with the USB PD standard. The printer performs the power negotiation with the power source after receiving supply of first power from the power source, and then receives supply of second power agreed in the power negotiation from the power source.

### DESCRIPTION

During the power negotiation, the above-described printer requests the power source to provide the amount of power to be consumed by the printer itself. Therefore, when an option unit, which is an example of a power consuming device, is connected to the printer, the printer may not be able to supply power required for the option unit even if the printer receives the supply of the second power after performing the power negotiation.

The present disclosure has been made in view of the above circumstances, and an object thereof is to supply power required for a power consuming device in an electronic device to which the power consuming device is connected.

(1) An electronic device of the present disclosure is an electronic device configured to receive supply of power from a power supply device. The electronic device includes: a controller; and a connection interface configured to be connected to a power consuming device. The controller is configured to receive supply of first power from the power supply device in accordance with a standard related to supply of power through a communication cable, and then perform power negotiation for requesting the power supply device to supply second power different from the first power. Before requesting the power supply device to supply the second power in the power negotiation, the controller is configured to acquire a supply condition of power required by the power consuming device connected to the connection interface, and determine the second power based on the acquired supply condition.

The electronic device is configured to temporarily receive supply of the first power from the power supply device in accordance with the standard related to the supply of power through the communication cable such as the USB-PD standard, perform the power negotiation for requesting the power supply device to supply the second power required for the operation of the electronic device, and then receive the second power from the power supply device. In an electronic device configured to request the power supply device to supply the power to be consumed by the electronic device itself during the power negotiation, in a case in which the power consuming device is connected, even if the supply of the second power is received after the power negotiation is performed, power required for the power consuming device may not be supplied. According to the electronic device, by acquiring the supply condition of power required by the power consuming device connected to the connection unit and requesting the power supply device to supply the second power based on the acquired power supply condition, it is possible to supply the power required for the power consuming device in a case in which the power consuming device is connected, thereby enabling the provision of the power required for the power consuming device.

(2) The standard may be a USB PD standard.

(3) In a case in which the power consuming device includes a CPU, the controller may be configured to supply, to the power consuming device, at least a part of the first power supplied from the power supply device to cause the CPU to operate, and acquire the supply condition from the CPU.

(4) In a case in which the power consuming device includes a first storage, the controller may be configured to supply, to the power consuming device, at least a part of the first power supplied from the power supply device, and acquire the supply condition from the first storage.

(5) The electronic device may further include a second storage configured to store the supply condition in association with an identifier of the power consuming device, and in a case in which the power consuming device includes a circuit configured to output a signal indicating the identifier of the power consuming device, the controller may be configured to cause the circuit to output the signal by using the first power supplied from the power supply device, and acquire, from the second storage, the supply condition corresponding to the identifier indicated by the signal output from the circuit.

(6) The electronic device may further include a second storage configured to store the supply condition in association with power to be consumed when the first power is supplied to the power consuming device, and the controller may be configured to acquire power to be consumed when causing the power consuming device to operate by using the first power supplied from the power supply device, and acquire, from the second storage, the supply condition corresponding to the acquired power to be consumed.

(7) The electronic device may further include a second storage configured to store a connection list including an identifier of the connection interface, and the controller may be configured to receive the supply of the first power from the power supply device, and then: execute determination processing of determining, for each identifier included in the connection list, whether the power consuming device is connected to the connection interface specified by the identifier; execute, in response to determining in the determination processing that the power consuming device is connected, acquisition processing of acquiring the supply condition for the power consuming device; and request, after executing the determination processing and the acquisition processing for all of identifiers included in the connection list, the power supply device to supply the second power based on all of supply conditions acquired in the acquisition processing.

(8) The controller may have at least a normal mode and a speed priority mode. In the normal mode, the controller may be configured to request, based on power to be consumed by the electronic device and the supply condition for the connected power consuming device, the power supply device to supply the second power corresponding to an operation condition of a case in which the electronic device and the power consuming device operate. In the speed priority mode, the controller may be configured to request the power supply device to supply the second power obtained by summing the power to be consumed by the electronic device and power satisfying the supply condition.

(9) The controller may have at least a normal mode and a power priority mode. In the normal mode, the controller may be configured to request, based on power to be consumed by the electronic device and the supply condition for the connected power consuming device, the power supply device to supply the second power corresponding to an operation condition of a case in which the electronic device and the power consuming device operate. In the power priority mode, the controller may be configured to request the power supply device to supply, as the second power, power to be consumed when the electronic device and the connected power consuming device operate under an operation condition in which power consumption of the electronic device and the connected power consuming device becomes smaller than that in the normal mode.

(10) The controller may be configured to allow a user to designate an operation condition of at least one of the electronic device or the power consuming device, and in response to the at least one of the electronic device or the power consuming device operating in accordance with the operation condition designated by the user, the controller may be configured to request the power supply device to supply the second power based on power to be consumed by the electronic device and the acquired supply condition.

(11) The electronic device may further include a second storage configured to store a connection list including an identifier of the connection interface and a priority of the connection interface, and when determining the second power based on the supply condition acquired for the power consuming device, the controller may be configured, in response to determining that power satisfying the supply condition excesses power allowed to be supplied to all of power consuming devices connected to the connection interface, to determine the second power by referring to the connection list and excluding the supply condition for the power consuming device connected to the connection interface having a low priority.

(12) The electronic device may further include: at least one of an image recording device configured to record an image on a recording medium or a scanner configured to read an image from the recording medium.

(13) The power consuming device may be any one of a scanner unit, an inkjet head, and a cutter unit, each of the scanner unit, the inkjet head and the cutter unit including a CPU and a storage.

(14) The power consuming device may be any one of a maintenance unit, a conveying unit, a roll paper unit, and an ADF, each of the maintenance unit, the conveying unit, the roll paper unit, and the ADF including a storage.

(15) The power consuming device may be any one of a cutter unit and an option tray, each of the cutter unit and the option tray including neither a CPU nor a storage.

(16) The power consuming device may be an external device including a CPU and a memory, and is any one of a personal computer, a tablet personal computer, a smartphone, and a communication device.

An electronic device of the present disclosure is an electronic device for receiving supply of power from a power supply device. The electronic device includes: a controller; and a connection interface configured to be connected to a power consuming device. In a state of receiving supply of first power from the power supply device in accordance with a USB PD standard, the controller is configured to acquire a supply condition of power required by the power consuming device connected to the connection interface, and perform power negotiation for requesting the power supply device to supply second power based on the acquired supply condition.

An electronic device of the present disclosure is an electronic device for receiving supply of power from a power supply device. The electronic device includes: a controller; and a connection interface configured to be connected to a power consuming device. After changing from a state of not being connected to the power supply device to a state of being connected to the power supply device, the electronic device is configured to receive supply of first power from the power supply device in accordance with a standard related to supply of power through a communication cable, and the controller is configured to start operating using the first power. After starting operating, the controller is configured to acquire a supply condition of power required by the power consuming device connected to the connection interface, and request the power supply device to supply second power larger than the first power based on the acquired supply condition.

According to the present disclosure, it is possible to supply power required for a power consuming device in an electronic device to which the power consuming device is connected.

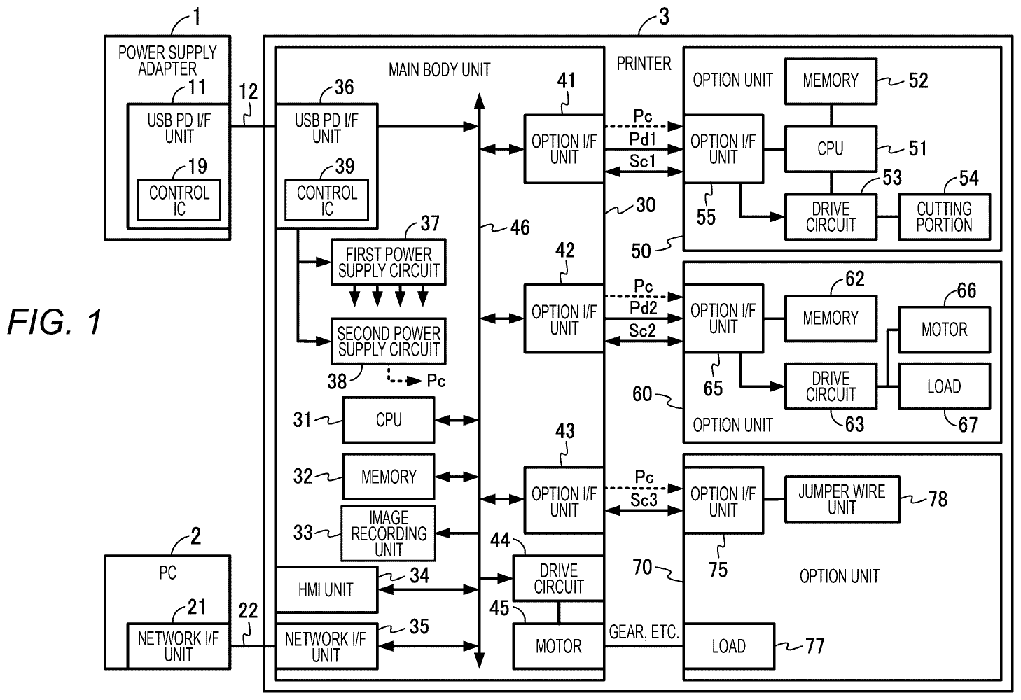

FIG. 1 is a block diagram illustrating a configuration of a printer 3 according to an embodiment.

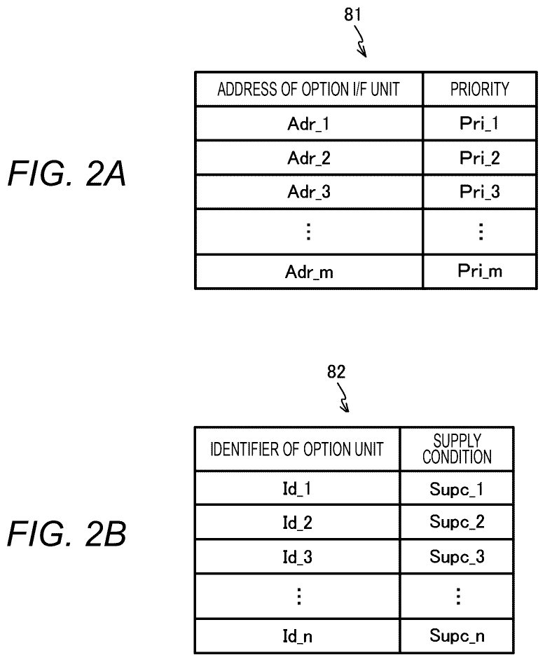

FIG. 2A is a diagram illustrating a connection list 81 stored in a memory 32 of the printer 3. FIG. 2B is a diagram illustrating a supply condition table 82 stored in the memory 32.

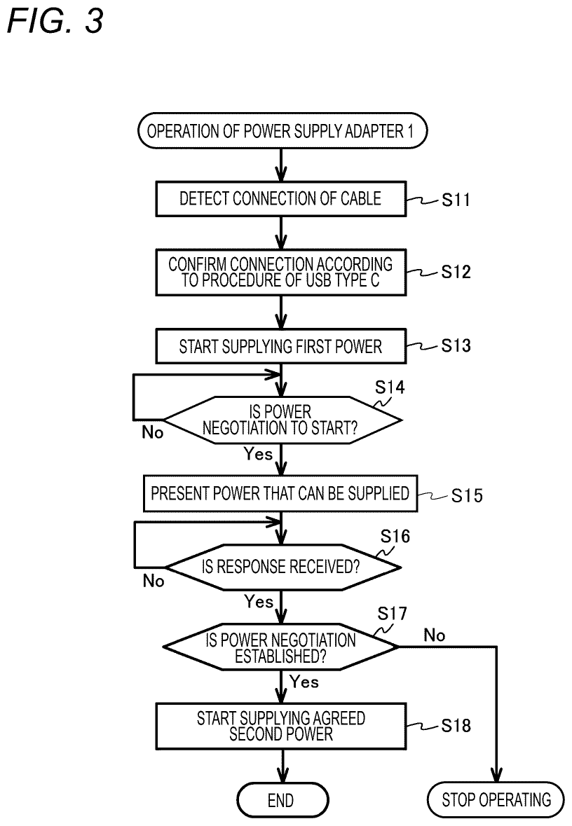

FIG. 3 is a flowchart illustrating an operation of a power supply adapter 1 illustrated in FIG. 1 when a cable is connected.

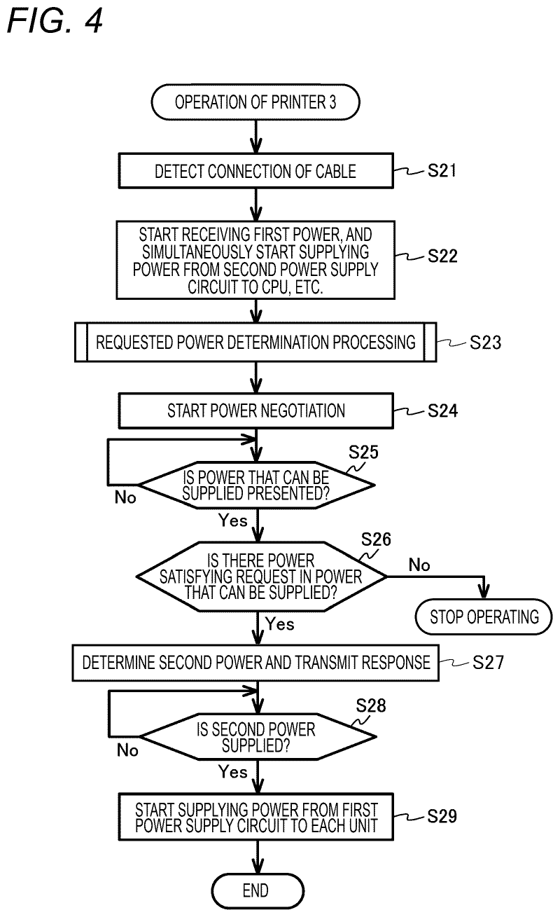

FIG. 4 is a flowchart illustrating an operation of the printer 3 when the cable is connected.

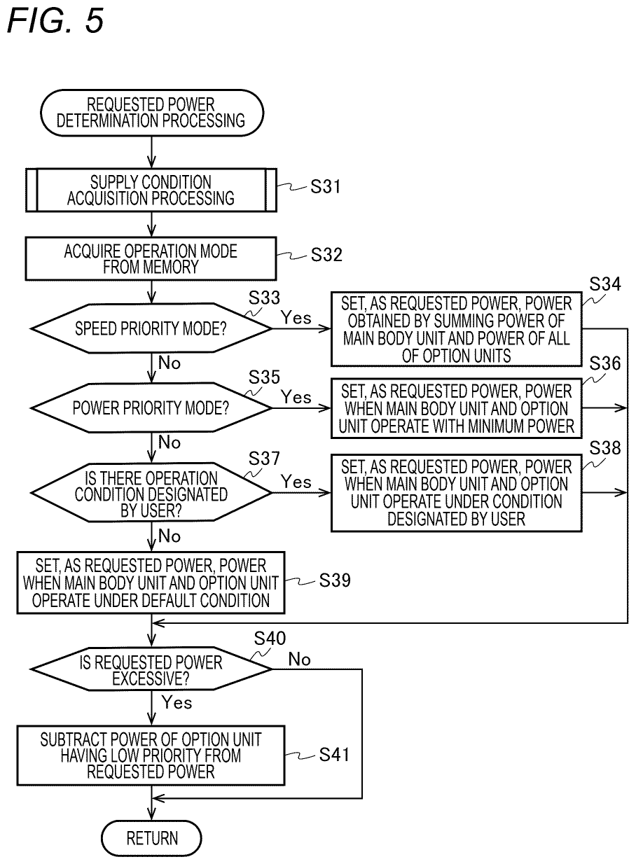

FIG. 5 is a flowchart of requested power determination processing illustrated in FIG. 4.

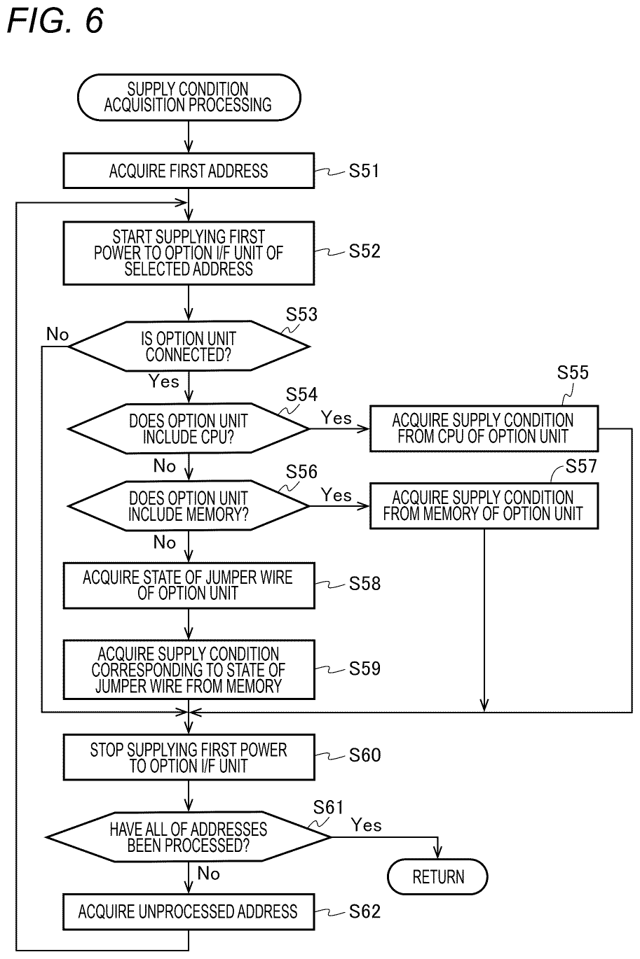

FIG. 6 is a flowchart of supply condition acquisition processing illustrated in FIG. 5.

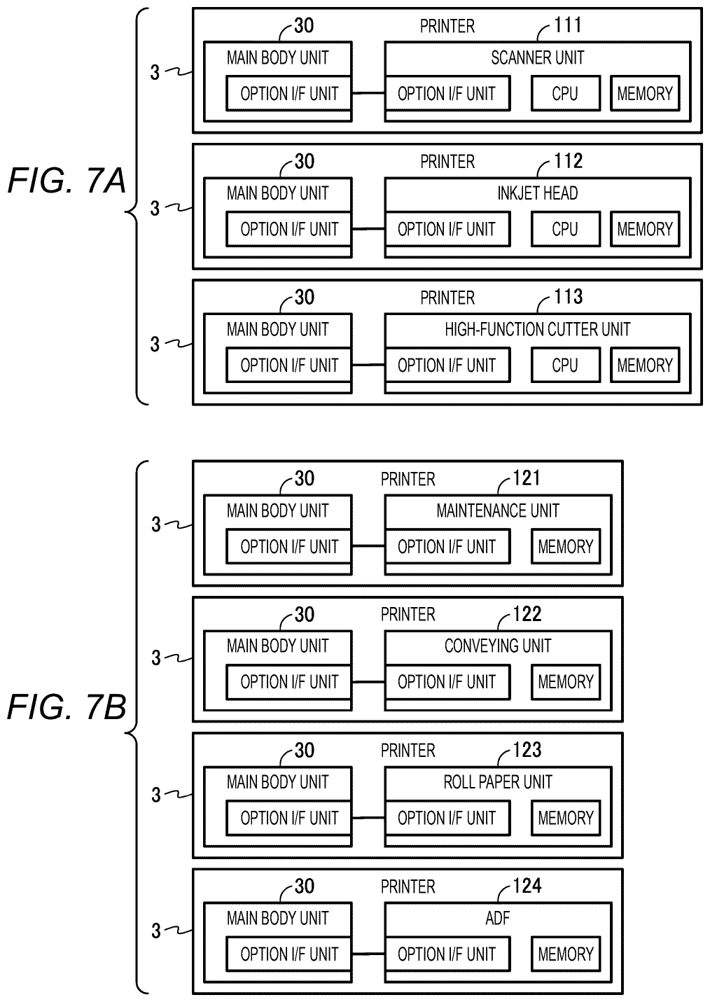

FIG. 7A is a diagram illustrating examples of an option unit connected to the printer 3. FIG. 7B is a diagram illustrating other examples of the option unit connected to the printer 3.

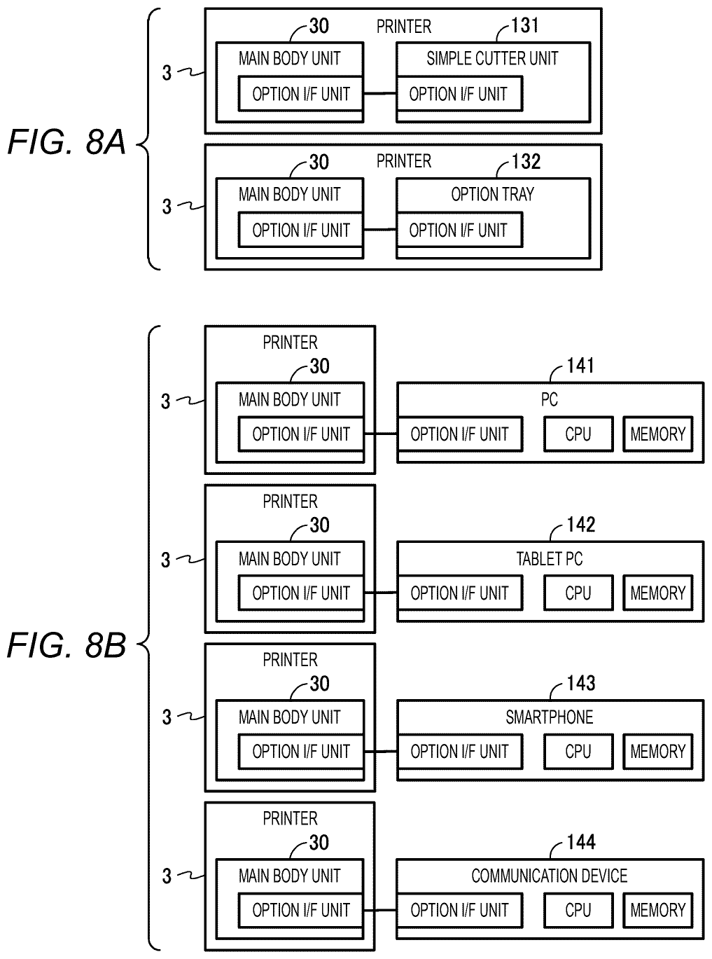

FIG. 8A is a diagram illustrating other examples of the option unit connected to the printer 3.

FIG. 8B is a diagram illustrating examples of an external device connected to the printer 3.

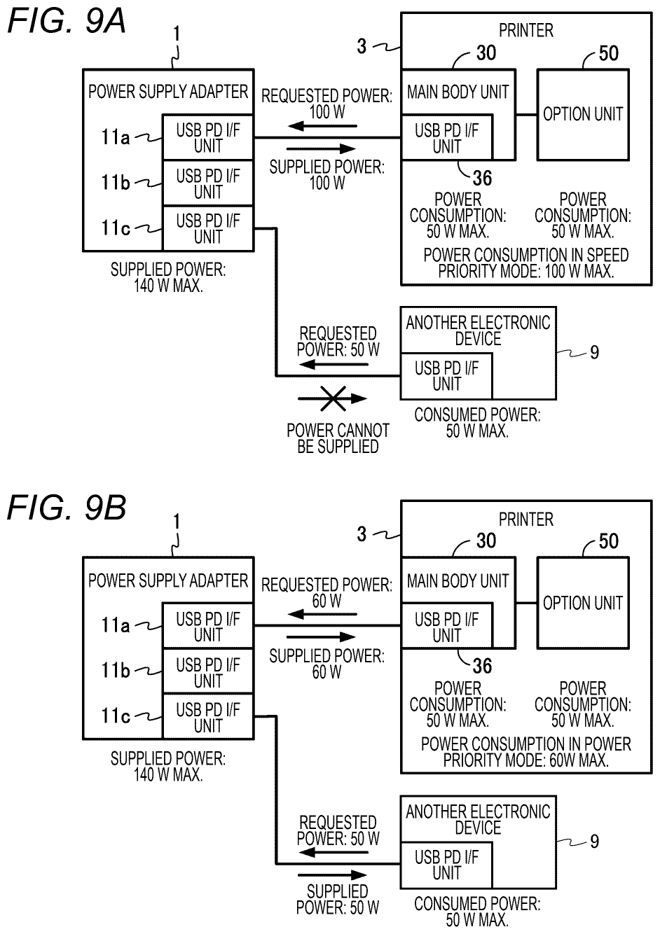

FIG. 9A a diagram illustrating a case in which another electronic device 9 is connected to the power supply adapter 1 connected to the printer 3 operating in a speed priority mode. FIG. 9B is a diagram illustrating a case in which the another electronic device 9 is connected to the power supply adapter 1 connected to the printer 3 operating in a power priority mode.

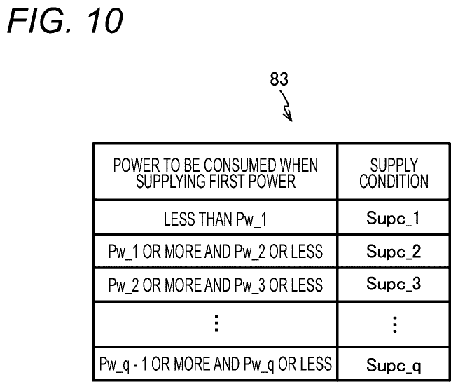

FIG. 10 is a diagram illustrating a supply condition table 83 stored in the memory 32 of a printer 3 according to a modification.

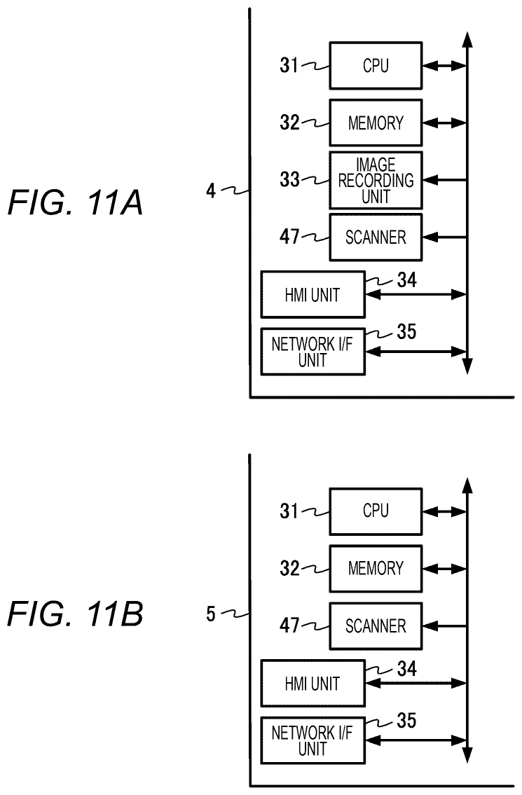

FIG. 11A is a diagram illustrating some components of a printer 4 according to a modification.

FIG. 11B is a diagram illustrating some components of a scanner device 5.

Hereinafter, a printer 3 according to an embodiment will be described. The embodiment to be described below is merely an example of the present disclosure, and it is needless to say that the embodiment can be appropriately modified without departing from the gist of the present disclosure. In the following description, a personal computer may be abbreviated as “PC”, an interface may be abbreviated as “I/F”, and a “USB PD” may be referred to as “USB-PD”.

### [Configuration of Printer 3]

As illustrated in FIG. 1, the printer 3 according to the embodiment is connected to a power supply adapter 1 and a PC 2. The power supply adapter 1 supplies power to the printer 3. The PC 2 transmits commands, image data, and the like to the printer 3. The printer 3 receives supply of power from the power supply adapter 1 and records an image on a recording medium based on the command, the image data, and the like received from the PC 2.

The printer 3 includes a main body unit 30. The main body unit 30 includes a central processing unit (CPU) 31, a memory 32, an image recording unit 33, a human machine interface (HMI) unit 34, a network I/F unit 35, a USB-PD I/F unit 36, a first power supply circuit 37, a second power supply circuit 38, three option I/F units 41 to 43, a drive circuit 44, and a motor 45. The CPU 31, the memory 32, the image recording unit 33, the HMI unit 34, the network I/F unit 35, the USB-PD I/F unit 36, the option I/F units 41 to 43, and the drive circuit 44 are connected to a bus 46 of the main body unit 30.

The option I/F units 41 to 43 are configured to connect an option unit or an external device. In the example illustrated in FIG. 1, the option I/F units 41 to 43 are connected to option units 50, 60, and 70, respectively. The number of option I/F units included in the main body unit 30 is optional, and may be two or less or four or more.

The CPU 31 controls the operation of the printer 3. The CPU 31 performs processing of controlling power to be supplied from the power supply adapter 1 to the printer 3 (details will be described later). The memory 32 is a working memory of the CPU 31. The memory 32 stores various types of data required for the operation of the CPU 31. The image recording unit 33 records an image on the recording medium under the control of the CPU 31. The image recording unit 33 includes, for example, a conveying unit (not illustrated) that conveys the recording medium along a conveying path, a recording head (not illustrated) that moves in a direction intersecting the conveying path and records an image on the recording medium. The HMI unit 34 has an input function of receiving a command from a user and a display function of displaying a screen indicating a state of the printer 3 and the like. The HMI unit 34 is, for example, a touch panel.

The power supply adapter 1 and the printer 3 are connected using a type C USB cable 12. The power supply adapter 1 includes a USB-PD I/F unit 11. One end of the USB cable 12 is connected to the USB-PD I/F unit 11 of the power supply adapter 1. The other end of the USB cable 12 is connected to the USB-PD I/F unit 36 of the printer 3.

The USB-PD I/F units 11 and 36 include control ICs 19 and 39, respectively. When the USB cable 12 is connected to the USB-PD I/F unit 11 of the power supply adapter 1, the control IC 19 performs the operation illustrated in FIG. 3. When the USB cable 12 is connected to the USB-PD I/F unit 36 of the printer 3, the CPU 31 and the control IC 39 perform operations illustrated in FIGS. 4 to 6. The control ICs 19 and 39 operate in accordance with a USB-PD standard.

The PC 2 and the printer 3 are connected using a communication cable 22. The PC 2 includes a network I/F unit 21. One end of the communication cable 22 is connected to the network I/F unit 21 of the PC 2. The other end of the communication cable 22 is connected to the network I/F unit 35 of the printer 3. The PC 2 transmits commands, image data, and the like to the printer 3 via the network I/F units 21 and 35.

The PC 2 and the printer 3 communicate with each other in accordance with an optional wired communication standard. The PC 2 and the printer 3 may perform communication in accordance with a standard such as USB or RS-232C. Alternatively, the PC 2 and the printer 3 may perform communication in accordance with a wireless communication standard such as Wi-Fi (registered trademark) or Bluetooth (registered trademark) without being connected to the communication cable 22.

The first power supply circuit 37 and the second power supply circuit 38 convert a voltage supplied from the power supply adapter 1 into a voltage of a predetermined level, and supply the converted voltage to each unit of the printer 3 and the option units 50, 60, and 70. The printer 3 first receives supply of first power from the power supply adapter 1, and then performs power negotiation for requesting the power supply adapter 1 to supply second power different from the first power. Thereafter, the printer 3 receives supply of the second power agreed in the power negotiation from the power supply adapter 1.

The first power supply circuit 37 does not operate when the printer 3 receives the supply of the first power, and operates when the printer 3 receives the supply of the second power. The second power supply circuit 38 operates both when the printer 3 receives the supply of the first power and when the printer 3 receives the supply of the second power. The CPU 31 has a function of detecting whether the first power supply circuit 37 operates and a function of detecting whether the second power supply circuit 38 operates.

### [Option Units 50, 60, 70]

The option unit 50 has a control function independent of the main body unit 30. The option unit 50 is, for example, a cutting unit that cuts the recording medium which is conveyed by the conveying unit and on which an image is recorded by the recording head. The option unit 50 includes a CPU 51, a memory 52, a drive circuit 53, a cutting portion 54, and an option I/F unit 55.

The option I/F unit 41 of the main body unit 30 and the option I/F unit 55 of the option unit 50 are connected by a power supply line and a signal line. When the printer 3 receives the supply of the first power from the power supply adapter 1, communication power Pc is supplied from the main body unit 30 to the option unit 50 via the power supply line. The communication power Pc is first power or power lower than first power based on the first power. That is, the communication power Pc is at least a part of the first power. When the printer 3 receives the supply of the second power from the power supply adapter 1, driving power Pd1 is supplied from the main body unit 30 to the option unit 50 via the power supply line. The driving power Pd1 is power based on the second power. The driving power Pd1 may be power smaller than the second power or power larger than the second power. A communication signal Sc1 is transmitted and received between the main body unit 30 and the option unit 50 via the signal line.

The CPU 51 is connected to the memory 52, the drive circuit 53, and the option I/F unit 55. The CPU 51 controls the drive circuit 53 in accordance with the communication signal Sc1 received from the main body unit 30. In response to a request from the main body unit 30, the CPU 51 transmits an identifier of the option unit 50 to the main body unit 30 via the option I/F units 41 and 55. The drive circuit 53 is connected to the CPU 51, the cutting portion 54, and the option I/F unit 55, receives the driving power Pd1 from the main body unit 30, and drives the cutting portion 54 under the control of the CPU 51.

The option unit 60 does not include a CPU and includes a drive circuit and a motor controlled by the main body unit 30. The option unit 60 is, for example, an automatic document feeder (ADF) that automatically feeds a document. The option unit 60 includes a memory 62, a drive circuit 63, an option I/F unit 65, a motor 66, and a load 67.

The option I/F unit 42 of the main body unit 30 and the option I/F unit 65 of the option unit 60 are connected by a power supply line and a signal line. When the printer 3 receives the supply of the first power from the power supply adapter 1, communication power Pc is supplied from the main body unit 30 to the option unit 60 via the power supply line. When the printer 3 receives the supply of the second power from the power supply adapter 1, driving power Pd2 is supplied from the main body unit 30 to the option unit 60 via the power supply line. Similarly to the driving power Pd1, the driving power Pd2 is power based on the second power. A communication signal Sc2 is transmitted and received between the main body unit 30 and the option unit 60 via the signal line.

The memory 62 stores an identifier of the option unit 60 and is connected to the option I/F unit 65. The identifier of the option unit 60 stored in the memory 62 is transmitted to the main body unit 30 via the option I/F units 42 and 65 in response to a request from the main body unit 30. The drive circuit 63 is connected to the option I/F unit 65, the motor 66, and the load 67. The drive circuit 63 receives the driving power Pd2 supply from the main body unit 30 and drives the motor 66 and the load 67 in accordance with the communication signal Sc2 received from the main body unit 30.

The option unit 70 does not include a CPU, a drive circuit, or a motor, and includes a load driven by the main body unit 30. The option unit 70 is, for example, an option tray. The option unit 70 includes an option I/F unit 75, a load 77, and a jumper wire unit 78.

The option I/F unit 43 of the main body unit 30 and the option I/F unit 75 of the option unit 70 are connected by a power supply line and a signal line. When the printer 3 receives the supply of the first power from the power supply adapter 1, communication power Pc is supplied from the main body unit 30 to the option unit 70 via the power supply line. A communication signal Sc3 is transmitted and received between the main body unit 30 and the option unit 70 via the signal line. The motor 45 and the load 77 are connected by a gear or the like (not illustrated).

The drive circuit 44 is a drive circuit of the motor 45. The load 77 is a load of the motor 45. The drive circuit 44 drives the motor 45 and the load 77 under the control of the CPU 31. The jumper wire unit 78 includes a plurality of jumper wires, and outputs a signal indicating an identifier of the option unit 70 in response to a request from the main body unit 30. For example, when the jumper wire unit 78 includes three jumper wires J1 to J3, the jumper wire unit 78 outputs one of eight types of signals depending on a short-circuit state or a connected state of each of the jumper wires J1 to J3. The output signal of the jumper wire unit 78 indicates which of Id1 to Id8 the identifier of the option unit 70 is.

When (J1, J2, J3)=(short-circuit, short-circuit, short-circuit): the identifier is Id_1.

When (J1, J2, J3)=(short-circuit, short-circuit, connected): the identifier is Id_2.

When (J1, J2, J3)=(short-circuit, connected, short-circuit), the identifier is Id_3.

When (J1, J2, J3)=(short-circuit, connected, connected): the identifier is Id_4.

When (J1, J2, J3)=(connected, short-circuit, short-circuit), the identifier is Id_5.

When (J1, J2, J3)=(connected, short-circuit, connected): the identifier is Id_6.

When (J1, J2, J3)=(connected, connected, short-circuit): the identifier is Id_7.

When (J1, J2, J3)=(connected, connected, connected): the identifier is Id_8.

### [Data Stored in Memory 32]

The memory 32 stores a connection list 81 illustrated in FIG. 2A and a supply condition table 82 illustrated in FIG. 2B. The connection list 81 stores addresses and priorities for m (m is a natural number) option I/F units of the main body unit 30. For example, the connection list 81 illustrated in FIG. 2A stores addresses Adr_1 to Adr_m and priorities Pri_1 to Pri_m for m option I/F units of the main body unit 30.

The supply condition table 82 stores supply conditions of power required by the option unit in association with the identifier of the option unit. The supply condition of power is designated by, for example, a pair of voltage and current. The supply condition table 82 stores identifiers and supply conditions for n types (n is a natural number) of option units that can be connected to the option I/F units 41 to 43. For example, the supply condition table 82 illustrated in FIG. 2B stores identifiers Id_1 to Id_n and supply conditions Supc_1 to Supc_n for n types of option units that can be connected to the option I/F units 41 to 43.

### [Operation of Power Supply Adapter 1]

When the USB cable 12 is connected to the USB-PD I/F unit 11 of the power supply adapter 1, the control IC 19 performs the operation illustrated in FIG. 3. The control IC 19 first detects that the USB cable 12 is connected to the USB-PD I/F unit 11 (S11).

Next, the control IC 19 confirms the connection according to a procedure of USB type C (S12). In S12, the control IC 19 confirms that a power sink (here, the printer 3) is connected to the other end of the USB cable 12. Next, the control IC 19 starts supplying the first power to the printer 3 according to the USB-PD standard (S13). In S13, the control IC 19 starts supplying the voltage of 5 V converted by the power supply adapter 1 to the printer 3.

Next, the control IC 19 determines whether to start power negotiation with the printer 3 (S14). In S14, when the control IC 19 receives a signal indicating the start of the power negotiation from the printer 3, the control IC 19 determines to start the power negotiation. The signal indicating the start of the power negotiation is a signal transmitted by the printer 3 in S24 illustrated in FIG. 4. The control IC 19 proceeds to S14 when determining not to start the power negotiation (S14: No), and proceeds to S15 when determining to start the power negotiation (S14: Yes).

In the latter case, the control IC 19 presents power that can be supplied to the printer 3 in accordance with the USB-PD standard (S15). In S15, the control IC 19 outputs a signal indicating the power that can be supplied from the power supply adapter 1. The signal transmitted in S15 indicates, by using a pair of voltage and current, the power that can be supplied.

Next, the control IC 19 determines whether a response is received from the printer 3 (S16). In S16, when the printer 3 receives the response transmitted in S27 illustrated in FIG. 4, the control IC 19 determines that the response is received from the printer 3. The control IC 19 proceeds to S16 when determining that the response is not received from the printer 3 (S16: No), and proceeds to S17 when determining that the response is received from the printer 3 (S16: Yes).

In the latter case, the control IC 19 determines whether the power negotiation with the printer 3 is established (S17). When the second power requested in the response received in S16 is included in the power that can be supplied presented in S15, the control IC 19 determines that the power negotiation is established. When determining that the power negotiation is not established (S17: No), the control IC 19 stops the operation. In this case, the power supply adapter 1 does not supply the second power to the printer 3.

When determining in S17 that the power negotiation is established (S17: Yes), the control IC 19 proceeds to S18. In this case, the control IC 19 starts supplying the power agreed in the power negotiation to the printer 3 (S18). In S18, the control IC 19 starts supplying the printer 3 with the voltage generated by the power supply adapter 1 and agreed in the power negotiation. After the control IC 19 executes S18, the voltage agreed in the power negotiation is supplied from the power supply adapter 1 to the printer 3. However, a current flowing from the power supply adapter 1 to the printer 3 is limited to a current agreed in the power negotiation or less.

### [Operation of Printer 3]

When the USB cable 12 is connected to the USB-PD I/F unit 36 of the printer 3, the CPU 31 and the control IC 39 perform the operations illustrated in FIGS. 4 to 6. The control IC 39 first detects that the USB cable 12 is connected to the USB-PD I/F unit 36 (S21).

Next, the control IC 39 starts receiving the first power supplied from the power supply adapter 1, and simultaneously starts supplying power from the second power supply circuit 38 to the CPU 31, the memory 32, and the like (S22). In S22, the control IC 39 starts receiving the voltage of 5 V supplied from the power supply adapter 1, controls the second power supply circuit 38 to convert the received voltage of 5 V into a voltage of a predetermined level, and starts supplying the level-converted voltage to the CPU 31, the memory 32, and the like. The supply of the first power is started by the power supply adapter 1 in S13 illustrated in FIG. 3. After the control IC 39 executes S22, the CPU 31 starts operating.

When starting operating, the CPU 31 performs requested power determination processing illustrated in FIG. 5 (S23). In step S23, the CPU 31 acquires supply conditions of power required by the option units 50, 60, and 70 connected to the option I/F units 41 to 43, and determines the second power different from the first power based on the acquired power supply conditions (details will be described later).

After the CPU 31 executes S23, the control IC 39 starts power negotiation with the power supply adapter 1 (S24). In S24, the control IC 39 transmits the signal indicating the start of the power negotiation to the power supply adapter 1.

Next, the control IC 39 determines whether the power that can be supplied is presented from the power supply adapter 1 (S25). The power that can be supplied is presented by the power supply adapter 1 in S15 illustrated in FIG. 3. When determining that the power that can be supplied is not presented (S25: No), the control IC 39 proceeds to S25. When the control IC 39 determines that the power that can be supplied is presented (S25: Yes), the CPU 31 executes S26.

In the latter case, the CPU 31 determines whether there is power satisfying the request of the printer 3 in the power that can be supplied presented from the power supply adapter 1 (S26). When determining that there is no power satisfying the request (S26: No), the CPU 31 stops operating. In this case, the printer 3 does not request the power supply adapter 1 to supply the second power and does not receive the supply of the second power from the power supply adapter 1.

When determining that there is power satisfying the request (S26: Yes), the CPU 31 proceeds to S27. In this case, the CPU 31 determines the second power to be requested with respect to the power supply adapter 1, and transmits a response to the power supply adapter 1 (S27). In S27, the CPU 31 selects power satisfying the request from the power that can be supplied presented from the power supply adapter 1, and determines the selected power as the second power to be requested with respect to the power supply adapter 1. The CPU 31 controls the control IC 39 to transmit a response including the determined second power to the power supply adapter 1.

After the CPU 31 executes S27, the control IC 39 determines whether the second power is supplied from the power supply adapter 1 (S28). In S28, the control IC 39 determines that the second power is supplied when the voltage of the power supply line included in the USB cable 12 reaches the level requested in S27. The control IC 39 proceeds to S28 when determining that the second power is not supplied (S28: No), and proceeds to S29 when determining that the second power is supplied (S28: Yes).

In the latter case, the control IC 39 starts supplying power from the first power supply circuit 37 to each unit of the main body unit 30 and the option units 50 and 60 (S29). In S29, the control IC 39 controls the first power supply circuit 37 to convert the voltage supplied from the power supply adapter 1 into a voltage of a predetermined level, and starts supplying the converted voltage to the image recording unit 33, the HMI unit 34, the network I/F unit 35, the option units 50 and 60, and the like. After the control IC 39 executes S29, power required for the operation of each unit is supplied to the image recording unit 33, the HMI unit 34, the network I/F unit 35, and the like, and the driving power Pd1 and Pd2 are supplied to the option units 50 and 60, respectively.

### [Requested Power Determination Processing and Supply Condition Acquisition Processing]

Hereinafter, the requested power determination processing executed by the CPU 31 in S23 will be described with reference to FIGS. 5 and 6. The CPU 31 executes supply condition acquisition processing illustrated in FIG. 6 at the beginning of the requested power determination processing (S31).

At the beginning of the supply condition acquisition processing, the CPU 31 acquires a first address from the connection list 81 (FIG. 2A) stored in the memory 32 (S51). In S51, for example, the CPU 31 acquires the first address Adr_1 from the connection list 81.

Next, the CPU 31 starts supplying the first power to the option I/F unit of the selected address (S52). For example, in S52, the CPU 31 starts supplying a voltage of 5 V to the option I/F unit of the address acquired in S51 or S62 (described later). For example, when the address selected in S51 is Adr_1, a voltage of 5 V is supplied from the main body unit 30 to the option unit 50 connected to the option I/F unit 41. When the address selected in S62 is Adr_2, the voltage of 5 V is supplied from the main body unit 30 to the option unit 60 connected to the option I/F unit 42.

Next, the CPU 31 determines whether the option unit is connected to the option I/F unit (S53). In S53, for example, the CPU 31 determines, based on the level of a signal connected to the option I/F unit, whether the option unit is connected to the option I/F unit of the address acquired in S51 or S62. When determining that the option unit is connected (S53: Yes), the CPU 31 proceeds to S54.

In this case, the CPU 31 determines whether the option unit includes a CPU (S54). In S54, for example, the CPU 31 determines, based on whether a signal indicating that the option unit includes a CPU is received from the option unit within a predetermined time, whether the option unit connected to the option I/F unit of the address acquired in S51 or S62 includes a CPU. When determining that the option unit includes a CPU (S54: Yes), the CPU 31 proceeds to S55. In this case, the CPU 31 acquires the supply condition from the CPU of the option unit (S55). In S55, for example, the CPU 31 acquires the supply condition from the CPU 51 of the option unit 50 to which the communication power Pc of 5 V is supplied.

When determining in S54 that the option unit does not include a CPU (S54: No), the CPU 31 proceeds to S56. In this case, the CPU 31 determines whether the option unit includes a memory (S56). In S56, for example, the CPU 31 determines, based on whether a signal indicating that the option unit includes a memory is received from the option unit within a predetermined time, whether the option unit connected to the option I/F unit of the address acquired in S51 or S62 includes a memory. When determining that the option unit includes a memory (S56: Yes), the CPU 31 proceeds to S57. In this case, the CPU 31 acquires the supply condition from the memory of the option unit (S57). In S57, for example, the CPU 31 acquires the supply condition from the memory 62 of the option unit 60 to which the voltage of 5 Vis supplied.

When determining in S56 that the option unit does not include a memory (S56: No), the CPU 31 proceeds to S58. In this case, the CPU 31 acquires the states of the jumper wires of the option unit (S58). In S58, for example, the CPU 31 accesses the jumper wire unit 78 of the option unit 70 and acquires the states of the three jumper wires J1 to J3 included in the jumper wire unit 78.

Next, the CPU 31 acquires the supply condition corresponding to the acquired states of the jumper wires from the memory 32 (S59). In S59, the CPU 31 acquires the identifier of the option unit corresponding to the states of the jumper wires acquired in S58, and acquires the supply condition corresponding to the acquired identifier of the option unit from the supply condition table 82 (FIG. 2B) stored in the memory 32. For example, when the states of the jumper wires acquired in S58 indicates that the identifier of the option unit is Id_3, the CPU 31 acquires the supply condition Supc_3 corresponding to the identifier Id_3 from the supply condition table 82.

After executing S55, S57, or S59, the CPU 31 proceeds to S60. When determining in S53 that the option unit is not connected (S53: No), the CPU 31 proceeds to S60 without executing S54 to S59. Next, the CPU 31 stops supplying the first power to the option I/F unit (S60). In S60, the CPU 31 stops supplying the first power to the option unit of the address selected in S51 or S62.

Next, the CPU 31 determines whether all of the addresses of the option I/F units have been processed (S61). When determining that not all the addresses have not been processed (that is, there is an unprocessed address) (S61: No), the CPU 31 proceeds to S62. In this case, the CPU 31 acquires the unprocessed address from the connection list 81 stored in the memory 32 (S62), and proceeds to S52.

When determining in S61 that all the addresses have been processed (S61: Yes), the CPU 31 ends the supply condition acquisition processing and returns to S31 illustrated in FIG. 5.

After ending the supply condition acquisition processing in S31, the CPU 31 acquires an operation mode from the memory 32 (S32). The operation mode is one of a normal mode, a speed priority mode, and a power priority mode. In the normal mode, an operation condition of each unit included in the main body unit 30 and the option units 50, 60, and 70 may be designated. The operation condition of each unit is designated, for example, by the user operating the HMI unit 34.

Next, the CPU 31 determines whether the operation mode is the speed priority mode (S33). When determining that the operation mode is the speed priority mode (S33: Yes), the CPU 31 proceeds to S34. In this case, the CPU 31 sets the power obtained by summing the power of the main body unit 30 and the power of all of the option units connected to the option I/F units 41 to 43 as the requested power (S34). In S34, the CPU 31 acquires the power required by the option units 50, 60, and 70 based on the supply conditions acquired in the supply condition acquisition processing, and determines the power obtained by summing the power required by the main body unit 30 and the power required by the option units 50, 60, and 70 as the requested power to be requested from the power supply adapter 1.

When determining in S33 that the operation mode is not the speed priority mode (S33: No), the CPU 31 proceeds to S35. In this case, the CPU 31 determines whether the operation mode is the power priority mode (S35). When determining that the operation mode is the power priority mode (S35: Yes), the CPU 31 proceeds to S36. In this case, the CPU 31 sets the power when the main body unit 30 and the option unit operate with the minimum power as the requested power (S36). In S36, the CPU 31 acquires the power required by the option units 50, 60, and 70 based on the supply condition acquired in the supply condition acquisition processing, and determines the power when the main body unit 30 and the option units 50, 60, and 70 operate with the minimum power as the requested power to be requested from the power supply adapter 1.

When determining in S35 that the operation mode is not the power priority mode (S35: No), the CPU 31 proceeds to S37. In this case, the CPU 31 determines that the operation mode is the normal mode and determines whether there is an operation condition designated by the user (S37). When determining that there is an operation condition designated by the user (S37: Yes), the CPU 31 proceeds to S38. In this case, the CPU 31 determines, as the requested power to be requested from the power supply adapter 1, the power when the main body unit 30 and the option unit designated by the user operate under the condition designated by the user and the main body unit 30 and the option unit not designated by the user operate under the default condition.

When determining in S37 that there is no operation condition designated by the user (S37: No), the CPU 31 proceeds to S39. In this case, the CPU 31 determines the power when the main body unit 30 and the option unit operate under the default condition as the requested power to be requested from the power supply adapter 1.

As described above, in the speed priority mode, the CPU 31 determines the power obtained by summing the power to be consumed by the main body unit 30 and the power satisfying the supply condition as the requested power (S34), and in the power priority mode, the CPU 31 determines, as the requested power, the power consumed when the main body unit 30 and the connected option unit operate under an operation condition in which the power consumption is smaller than that in the normal mode (S36). In addition, in the normal mode, the CPU 31 determines, based on the power to be consumed by the main body unit 30 and the supply condition of the connected option unit, the power corresponding to the operation condition when the main body unit 30 and the option unit operate as the requested power (S39), and particularly, when there is an operation condition designated by the user, the CPU 31 determines, as the requested power, the power based on the power to be consumed by the main body unit 30 and the acquired supply condition when the main body unit 30 and the option unit designated by the user operate according to the operation condition designated by the user (S38).

After executing S34, S36, S38, or S39, the CPU 31 proceeds to S40. Next, the CPU 31 determines whether the requested power is excessive (S40). When determining in S40 that the power required to operate all the option units is insufficient to meet the requested power acquired in S34, S36, S38, or S39, the CPU 31 determines that the requested power is excessive.

When determining that the requested power is excessive (S40: Yes), the CPU 31 process proceeds to S41. In this case, the CPU 31 subtracts the power of the option unit having a low priority from the requested power (S41). In S41, the CPU 31 refers to the connection list 81 stored in the memory 32, detects the option unit connected to the option I/F unit having a low priority, and subtracts the power of the detected option unit from the requested power acquired in S34, S36, S38, or S39.

When determining in S40 that the requested power is not excessive (S40: No), or after executing S41, the CPU 31 ends the requested power determination processing and returns to after S23 illustrated in FIG. 4. Thereafter, in S27, the CPU 31 selects the power satisfying the request of the printer 3 from the power that can be supplied presented in S25, and determines the selected power as the second power to be requested from the power supply adapter 1. The second power is power different from the first power, and is power typically larger than the first power.

### Examples of Option Unit and External Device

Various types of option units can be connected to the option I/F units 41 to 43. As illustrated in FIG. 7A, for example, as an option unit including a CPU and a memory, a scanner unit 111, an inkjet head 112, a high-function cutter unit 113, and the like can be connected to the option I/F units 41 to 43. The high-function cutter unit 113 is a unit that cuts the recording medium into a complicated shape (for example, in accordance with a shape of an area in a scanned image).

As illustrated in FIG. 7B, as an option unit that not including a CPU and including a memory, a maintenance unit 121, a conveying unit 122, a roll paper unit 123, an ADF 124, and the like can be connected to the option I/F units 41 to 43.

As illustrated in FIG. 8A, as an option unit not including a CPU or a memory, a simple cutter unit 131, an option tray 132, and the like can be connected to the option I/F units 41 to 43. The simple cutter unit 131 is a unit that cuts the recording medium into a simple shape (for example, linearly). The option units illustrated in FIGS. 7A, 7B, and 8A are related units of the printer 3.

Instead of the related units of the printer 3, an external device of the printer 3 may be connected to the option I/F units 41 to 43 of the printer 3. As illustrated in FIG. 8B, as an external device including a CPU and a memory, a PC 141, a tablet PC 142, a smartphone 143, a communication device 144, and the like can be connected to the option I/F units 41 to 43.

In the above description, the printer 3 excluding the option units 50, 60, and 70, and the main body unit 30 are examples of an electronic device. The power supply adapter 1 is an example of a power supply device. The option units 50, 60, and 70, the scanner unit 111, the inkjet head 112, the high-function cutter unit 113, the maintenance unit 121, the conveying unit 122, the roll paper unit 123, the ADF 124, the simple cutter unit 131, the option tray 132, the PC 141, the tablet PC 142, the smartphone 143, and the communication device 144 are examples of a power consuming device.

The CPU 31 and the control IC 39 are examples of a controller of the electronic device. The option I/F units 41 to 43 are examples of a connection unit of the electronic device. The USB-PD standard is an example of a standard related to supply of power through a communication cable. The memory 62 is an example of a first storage unit of the power consuming device. The memory 32 is an example of a second storage unit of the electronic device. The address stored in the connection list 81 is an example of an identifier of the connection unit. The jumper wire unit 78 is an example of a circuit that outputs a signal indicating an identifier of the power consuming device. S53 is an example of determination processing of determining whether the power consuming device is connected. S31 is an example of acquisition processing of acquiring the supply condition for the power consuming device.

### Operation and Effect of Embodiment

As described above, the printer 3 according to the embodiment is the electronic device for receiving supply of power from the power supply adapter 1 (power supply device), and includes the controller including the CPU 31 and the control IC 39, and the option I/F units 41 to 43 (connection units) configured to connecting the option units 50, 60, and 70 (power consuming devices). The controller is configured to receive the supply of the first power from the power supply adapter 1 in accordance with the USB-PD standard (standard related to supply of power through the communication cable) (S22), and then perform power negotiation for requesting the power supply adapter 1 to supply the second power different from the first power (S24 to S26). The controller is configured to acquire the supply condition of power required by the option units 50, 60, and 70 connected to the option I/F units 41 to 43 (S23), and determine the second power based on the acquired power supply condition before requesting the second power in the power negotiation (S27).

In addition, in a state of receiving the supply of the first power from the power supply adapter 1 in accordance with the USB-PD standard, the controller acquires the supply condition of power required by the option units 50, 60, and 70 connected to the option I/F units 41 to 43 (S23), and performs power negotiation for requesting the power supply adapter 1 to supply the second power based on the acquired supply condition (S24 to S26).

After changing from a state of not being connected to the power supply adapter 1 to a state of being connected to the power supply adapter 1, the printer 3 receives the supply of the first power from the power supply adapter 1 in accordance with the USB-PD standard, and the controller starts operating using the first power (S22). After starting operating, the controller acquires the supply condition of power required by the option units 50, 60, and 70 connected to the option I/F units 41 to 43 (S31), and requests the power supply adapter 1 to supply the second power larger than the first power based on the acquired power supply condition (S27).

As described above, the printer 3 temporarily receives the first power from the power supply adapter 1 in accordance with the standard related to the supply of power through the communication cable such as the USB-PD standard, performs the power negotiation for requesting the power supply adapter 1 to supply the second power required for the operation of the printer 3, and then receives the second power from the power supply adapter 1. In the printer that requests the power supply adapter 1 to supply the power to be consumed by the printer 3 itself during the power negotiation, when the option unit 50 or the like is connected, even if the supply of the second power is received after the power negotiation is performed, power required for the option unit 50 or the like may not be supplied. According to the printer 3 of the embodiment, by acquiring the supply condition of power required by the option units 50, 60, and 70 connected to the option I/F units 41 to 43 and requesting the power supply adapter 1 to supply the second power based on the acquired power supply condition, it becomes possible to supply the power required for the option units 50, 60, and 70 when the option units 50, 60, and 70 are connected, thereby enabling the provision of the power required for the optional units 50, 60, and 70. In addition, the second power based on the supply condition can be requested for the option units 50, 60, and 70 through a procedure defined by the USB-PD standard.

If the printer always requests the power supply adapter 1 to supply the maximum power on the assumption that the option unit or the like is connected, there will be excess power that is not used by the printer. At this time, a part of power that can be supplied from the power supply adapter 1 may be unnecessarily occupied, and power may not be supplied from the power supply adapter 1 to another electronic device. According to the printer 3 of the embodiment, by requesting the power supply adapter 1 to supply power as little as possible to be consumed by the option units 50, 60, and 70 and the printer 3, the proportion of power supplied to the printer 3 out of the total power that can be supplied from the power supply adapter 1 can be reduced, and allowing the power supply adapter 1 to supply power more efficiently.

The above effect will be specifically described with reference to FIGS. 9A and 9B. FIGS. 9A and 9B each illustrates a case in which the printer 3 is connected to the power supply adapter 1 that supplies power to the printer 3, and another electronic device 9 is connected to the power supply adapter 1. The option unit 50 is connected to the main body unit 30 of the printer 3. It is assumed that the maximum power to be supplied by the power supply adapter 1 is 140 W, the maximum power to be consumed by each of the main body unit 30, the option unit 50, and the another electronic device 9 is 50 W, and the total power to be consumed by the main body unit 30 and the option unit 50 in the power priority mode is 60 W.

As illustrated in FIG. 9A, the printer 3 operating in the speed priority mode requests power of 100 W in the power negotiation with the power supply adapter 1. Since the requested power is equal to or less than the maximum power to be supplied by the power supply adapter 1, the power of 100 W is supplied from the power supply adapter 1 to the printer 3 after the power negotiation. Thereafter, when the another electronic device 9 is connected to the power supply adapter 1, the another electronic device 9 requests power of 50 W in the power negotiation with the power supply adapter 1. However, only a maximum power of 40 W can be supplied from the power supply adapter 1 already connected to the printer 3. Therefore, the power negotiation between the power supply adapter 1 and the another electronic device 9 is unsuccessful, and the power supply adapter 1 cannot supply power to the another electronic device 9.

Meanwhile, as illustrated in FIG. 9B, the printer 3 operating in the power priority mode requests power of 60 W in the power negotiation with the power supply adapter 1. After the power negotiation, the power of 60 W is supplied from the power supply adapter 1 to the printer 3. Thereafter, when the another electronic device 9 is connected to the power supply adapter 1, the another electronic device 9 requests power of 50 W in the power negotiation with the power supply adapter 1. In this case, the power supply adapter 1 already connected to the printer 3 can supply a maximum power of 80 W. Therefore, the power negotiation between the power supply adapter 1 and the another electronic device 9 is successful, and the power supply adapter 1 can supply power of 50 W to the another electronic device 9.

When the option unit 50 includes the CPU 51, the controller of the printer 3 supplies at least a part of the first power supplied from the power supply adapter 1 to the option unit 50 to operate the CPU 51, and acquires the supply condition from the CPU 51 (S55). When the option unit 50 includes the CPU 51, the supply condition may not be acquired unless the CPU 51 is operated. In such a case, the supply condition is acquired by supplying at least a part of the first power supplied from the power supply adapter 1 to the option unit 50 to operate the CPU 51 of the option unit 50.

When the option unit 60 includes the memory 62 (first storage unit), the controller supplies at least a part of the first power supplied from the power supply adapter 1 to the option unit 60, and acquires the supply condition from the memory 62 (S57). When the option unit 60 includes the memory 62, the supply condition may not be acquired from the memory 62 unless power is supplied to the option unit 60. In such a case, the supply condition is acquired by supplying at least a part of the first power supplied from the power supply adapter 1 to the option unit 60 to operate the memory 62 of the option unit 60.

The printer 3 further includes the memory 32 (second storage unit), and the memory 32 stores the supply conditions in association with the addresses (identifiers) of the option units 50, 60, and 70 (FIG. 2B). When the option unit 70 includes the jumper wire unit 78 (a circuit that outputs a signal indicating the identifier of the power consuming device), the controller causes the jumper wire unit 78 to output the signal by using the first power supplied from the power supply adapter 1, and acquires the supply condition corresponding to the identifier indicated by the output signal from the memory 32 (S58). Therefore, when the option unit 70 includes the jumper wire unit 78 that outputs the signal indicating the identifier of the option unit 70, the supply condition can be acquired from the memory 32 by causing the circuit to output the signal by using the first power supplied from the power supply adapter 1 and referring to the memory 32 using the identifier indicated by the output signal.

The memory 32 stores the connection list 81 including addresses (identifiers) of the option I/F units 41 to 43 (FIG. 2A). The controller receives the supply of the first power from the power supply adapter 1, and then executes determination processing (S53) of determining, for each identifier included in the connection list 81, whether the option units 50, 60, and 70 are connected to the option I/F units 41 to 43 specified by the identifiers, and acquisition processing (S55, S57, S58) of acquiring the supply condition for the option units 50, 60, and 70 when determining in the determination processing that the option units 50, 60, and 70 are connected, and requests the power supply adapter 1 to supply the second power based on all of the supply conditions acquired in the acquisition processing (S26) after executing the determination processing and the acquisition processing for all of the identifiers included in the connection list 81 (S61: Yes). Therefore, by using the connection list 81, it is possible to determine whether the option units 50, 60, and 70 are connected to the option I/F units 41 to 43, respectively, and to request the power supply adapter 1 to supply the second power based on the supply conditions for all of the connected option units 50, 60, and 70.

The controller has the normal mode, the speed priority mode, and the power priority mode. In the normal mode, the controller requests, based on the power to be consumed by the printer 3 and the supply conditions of the connected option units 50, 60, and 70, the power supply adapter 1 for the second power corresponding to the operation conditions when the printer 3 and the option units 50, 60, and 70 operate (S39). In the speed priority mode, the controller requests the power supply adapter 1 to supply the second power obtained by summing the power to be consumed by the printer 3 and the power satisfying the supply condition (S34). As described above, in the normal mode, the controller requests the power supply adapter 1 to supply the power to be consumed when the printer 3 and the option units 50, 60, and 70 operate under the default operation condition. Here, the operation condition changes depending on the types and the number of the connected option units 50, 60, and 70, and the maximum power consumption may also change according to the operation condition. For example, in a case in which the power to be consumed by the option units 50, 60, and 70 connected to the option I/F units 41 to 43 is large at an operation timing when the printer 3 consumes the maximum power, the power supply adapter 1 needs to supply large power. Meanwhile, when the power to be consumed by the option units 50, 60, and 70 connected to the option I/F units 41 to 43 is small at the operation timing when the printer 3 consumes the maximum power, the power supplied from the power supply adapter 1 is small. In this way, it is possible to request the power supply adapter 1 to supply more suitable second power by control such as confirming the operation condition or reading information from the memory 62. In the speed priority mode, the total power to be consumed by the printer 3 and the option units 50, 60, and 70 is requested from the power supply adapter 1. Accordingly, since the second power can be determined without being based on the operation condition, the second power can be quickly supplied.

In addition, in the power priority mode, the controller requests the power supply adapter 1 to supply, as the secondary power, power to be consumed when the printer 3 and the connected optional units 50, 60, and 70 operate under an operation condition that results in smaller power consumption than that in the normal mode (S36). As described above, in the normal mode, the controller requests the power supply adapter 1 to supply the power to be consumed when the printer 3 and the option units 50, 60, and 70 operate under the default operation condition. However, when the requested second power is larger than the power that can be supplied from the power supply adapter 1, the option units 50, 60, and 70 may not be supplied with the required power. In such a case, by requesting, as the second power, the power at the time of causing both the printer 3 and the option units 50, 60, and 70 to operate in the power priority mode, which is an operation condition that results in smaller power consumption than that in the normal mode, it is possible to operate both the printer 3 and the option units 50, 60, and 70 and supply the power required for the option units 50, 60, and 70.

The controller is configured to allow a user to designate an operation condition of at least one of the printer 3 or the option units 50, 60, and 70. When the printer 3 and the option units 50, 60, and 70 designated by the user operate according to the operation condition designated by the user, the controller requests the power supply adapter 1 to supply the second power based on the power to be consumed by the printer 3 and the acquired supply condition (S38). When one of the printer 3 and the option units 50, 60, and 70 designated by the user operates under the operation condition designated by the user, the operation is different from a normal operation, and the power consumption may increase or decrease accordingly. In this case, by requesting the power supply adapter 1 to supply the second power based on the power to be consumed by the printer 3 when operating under the operation condition designated by the user and the acquired supply condition, it is possible to receive suitable supply of the second power.

The memory 32 stores the connection list 81 including the addresses and the priorities of the option I/F units 41 to 43. When determining the second power based on the supply conditions acquired for the option units 50, 60, and 70, the controller determines the second power by referring to the connection list 81 and excluding the supply condition of the option unit 50, 60 or 70 connected to the connection unit having a low priority (S41) when determining that the power satisfying the supply conditions can not be supplied to all of the option units 50, 60, and 70 connected to the option I/F units 41 to 43 (S40: Yes). In this way, when the required power cannot be supplied to all of the option units 50, 60, and 70 connected to the printer 3, by determining the second power by excluding the supply condition of the option unit 50, 60 or 70 connected to the connection unit having a low priority, it is possible to supply the required power to the option unit 50, 60 or 70 connected to the remaining connection unit without supplying power to the option unit 50, 60 or 70 connected to the connection unit having a low priority.

The printer 3 further includes the image recording unit 33 that records an image on the recording medium. Therefore, when the option units 50, 60 and 70 are connected to the printer 3 provided with the image recording unit, it is possible to supply required power to the option units 50, 60, and 70. The option unit connected to the option I/F units 41 to 43 may be any one of the scanner unit 111, the inkjet head 112, and the cutter unit 113 each including a CPU and a memory (storage unit) (FIG. 7A), may be any one of the maintenance unit 121, the conveying unit 122, the roll paper unit 123, and the ADF 124 each including a memory (FIG. 7B), or may be any one of the simple cutter unit 131 and the option tray 132 each not including a CPU or a memory (FIG. 8A). An external device including a CPU and a memory may be connected to the option I/F units 41 to 43, and the external device may be any one of the PC 141, the tablet PC 142, the smartphone 143, and the communication device 144 (FIG. 8B). Accordingly, when the option unit or the external device is connected to the printer 3 provided with the image recording unit 33, it is possible to supply required power to the option unit or the external device.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modifications

Various modifications can be made for the printer 3 according to the embodiment. For example, the memory 32 of a printer according to a modification may store a supply condition table 83 illustrated in FIG. 10 instead of the supply condition table 82 illustrated in FIG. 2B. The supply condition table 83 stores the supply condition of power required by the option unit in association with the power to be consumed during the supply of the first power. The power to be consumed by when the option unit 70 is operated with the first power supplied from the power supply adapter 1 is divided into, for example, q (q is a natural number) ranges. The supply condition table 83 illustrated in FIG. 10 stores supply conditions Supc_1 to Supc_q for q ranges.

Instead of S58 and S59 of the supply condition acquisition processing (FIG. 6), the CPU 31 executes processing of measuring the power to be consumed by when the option unit 70 is operated with the first power supplied from the power supply adapter 1, and processing of acquiring the supply condition from the supply condition table 83 stored in the memory 32 based on the measured range of the power consumption.

In the printer according to the present modification, the memory 32 stores the supply condition in association with the power to be consumed by when the first power is supplied to the option unit 70, and the CPU 31 acquires the power to be consumed by when the option unit 70 is operated with the first power supplied from the power supply adapter 1, and acquires the supply condition corresponding to the acquired power to be consumed from the memory 32. Accordingly, the supply condition can be acquired from the memory 32.

As illustrated in FIG. 11A, a printer 4 according to a modification may include a scanner 47 that reads an image from a recording medium under control of the CPU 31, in addition to the image recording unit 33. As illustrated in FIG. 11B, an electronic device according to a modification may be a scanner device 5 including the scanner 47 without including the image recording unit 33.

According to the printer 3 of the embodiment, the printer 4 and the scanner device 5 of the modifications, when the power consuming device is connected to the electronic device including the image recording unit 33 or when the power consuming device is connected to the electronic device including the scanner 47, it is possible to supply required power to the power consuming device.

In the printer 3, the main body unit 30 and the option units 50, 60, and 70 may be connected in accordance with a predetermined standard, or may be connected in a unique manner. The option units 50, 60, and 70 may be freely connected to any of the option I/F units 41 to 43, and connectable option I/F units may be limited.

In the printer 3, the supply condition is stored in the memory 62 of the option unit 60, whereas in a printer according to a modification, the supply condition of the option unit 50 may be also stored in the memory 52 of the option unit 50, and the CPU 31 may acquire the supply condition from the memory 52 instead of from the CPU 51. In addition, in a printer according to a modification, the option units 50 and 60 may also include jumper wire units, and the CPU 31 may acquire the identifiers of the option units 50 and 60 from the jumper wire units of the option units 50 and 60. The option unit 70 may include a switch part including a plurality of switches (for example, DIP switches) or a circuit that fixedly outputs a specific identifier, instead of the jumper wire unit 78.

In the supply condition acquisition processing, the CPU 31 may acquire the supply condition of the option unit by processing other than S55 and S57 to S59 according to the configuration of the option unit. The CPU 31 may have an operation mode other than the normal mode, the speed priority mode, and the power priority mode, and in the requested power determination processing, the requested power may be determined by processing other than S34, S36, and S38 to S41. The CPU 31 may not execute S40 and S41 in the requested power determination processing.

In the printer 3, the CPU 31 and the control IC 39 included in the controller shares functions as described above, but in a printer according to a modification, the CPU 31 and the control IC 39 may share functions other than the above. For example, the control IC 39 may execute the steps described as being executed by the CPU 31, and the CPU 31 may execute the steps described as being executed by the control IC 39. The CPU 31 and the control IC 39 may be one CPU or one IC.

In the printer 3, the power supply adapter 1 and the printer 3 perform supply of power in accordance with the USB-PD standard, whereas in a printer 3 according to a modification, the power supply adapter 1 and the printer 3 may perform supply of power in accordance with a standard other than the USB-PD standard related to supply of power through a communication cable.

In the present disclosure, the electronic device may be any apparatus or device that operates by receiving supply of power from the power supply device, the power supply device may be any apparatus or device that can supply power, and the power consuming device may be any apparatus or device that can be connected to the electronic device. For example, the electronic device may be a multi function device having an image recording function, a scanning function, a FAX function, or the like, a PC, an electronic calculator, a communication device, a storage device, or the like, the power supply device may be a power source, a transformer, a storage battery, or the like, and the power consuming device may be an extension unit, an option unit, an additional unit, or the like.

What is claimed is:

1. An electronic device configured to receive supply of power from a power supply device, the electronic device comprising:
a controller; and
a connection interface configured to be connected to a power consuming device,
wherein the controller is configured to receive supply of first power from the power supply device in accordance with a standard related to supply of power through a communication cable, and then perform power negotiation for requesting the power supply device to supply second power different from the first power, and
wherein before requesting the power supply device to supply the second power in the power negotiation, the controller is configured to acquire a supply condition of power required by the power consuming device connected to the connection interface, and determine the second power based on the acquired supply condition.

2. The electronic device according to claim 1,
wherein the standard is a USB PD standard.

3. The electronic device according to claim 2,
wherein in a case in which the power consuming device comprises a CPU, the controller is configured to supply, to the power consuming device, at least a part of the first power supplied from the power supply device to cause the CPU to operate, and acquire the supply condition from the CPU.

4. The electronic device according to claim 2,
wherein in a case in which the power consuming device comprises a first storage, the controller is configured to supply, to the power consuming device, at least a part of the first power supplied from the power supply device, and acquire the supply condition from the first storage.

5. The electronic device according to claim 2, further comprising:
a second storage configured to store the supply condition in association with an identifier of the power consuming device,
wherein in a case in which the power consuming device comprises a circuit configured to output a signal indicating the identifier of the power consuming device, the controller is configured to cause the circuit to output the signal by using the first power supplied from the power supply device, and acquire, from the second storage, the supply condition corresponding to the identifier indicated by the signal output from the circuit.

6. The electronic device according to claim 2, further comprising:
a second storage configured to store the supply condition in association with power to be consumed when the first power is supplied to the power consuming device,
wherein the controller is configured to acquire power to be consumed when causing the power consuming device to operate by using the first power supplied from the power supply device, and acquire, from the second storage, the supply condition corresponding to the acquired power to be consumed.

7. The electronic device according to claim 2, further comprising:
a second storage configured to store a connection list including an identifier of the connection interface,
wherein the controller is configured to receive the supply of the first power from the power supply device, and then:
execute determination processing of determining, for each identifier included in the connection list, whether the power consuming device is connected to the connection interface specified by the identifier;
execute, in response to determining in the determination processing that the power consuming device is connected, acquisition processing of acquiring the supply condition for the power consuming device; and
request, after executing the determination processing and the acquisition processing for all of identifiers included in the connection list, the power supply device to supply the second power based on all of supply conditions acquired in the acquisition processing.

8. The electronic device according to claim 2,
wherein the controller has at least a normal mode and a speed priority mode,
wherein in the normal mode, the controller is configured to request, based on power to be consumed by the electronic device and the supply condition for the connected power consuming device, the power supply device to supply the second power corresponding to an operation condition of a case in which the electronic device and the power consuming device operate, and
wherein in the speed priority mode, the controller is configured to request the power supply device to supply the second power obtained by summing the power to be consumed by the electronic device and power satisfying the supply condition.

9. The electronic device according to claim 2,
wherein the controller has at least a normal mode and a power priority mode,
wherein in the normal mode, the controller is configured to request, based on power to be consumed by the electronic device and the supply condition for the connected power consuming device, the power supply device to supply the second power corresponding to an operation condition of a case in which the electronic device and the power consuming device operate, and
wherein in the power priority mode, the controller is configured to request the power supply device to supply, as the second power, power to be consumed when the electronic device and the connected power consuming device operate under an operation condition in which power consumption of the electronic device and the connected power consuming device becomes smaller than that in the normal mode.

10. The electronic device according to claim 2,
wherein the controller is configured to allow a user to designate an operation condition of at least one of the electronic device or the power consuming device, and
wherein in response to the at least one of the electronic device or the power consuming device operating in accordance with the operation condition designated by the user, the controller is configured to request the power supply device to supply the second power based on power to be consumed by the electronic device and the acquired supply condition.

11. The electronic device according to claim 2, further comprising:
a second storage configured to store a connection list including an identifier of the connection interface and a priority of the connection interface,
wherein when determining the second power based on the supply condition acquired for the power consuming device, the controller is configured, in response to determining that power satisfying the supply condition excesses power allowed to be supplied to all of power consuming devices connected to the connection interface, to determine the second power by referring to the connection list and excluding the supply condition for the power consuming device connected to the connection interface having a low priority.

12. The electronic device according to claim 1, further comprising:
at least one of an image recording device configured to record an image on a recording medium or a scanner configured to read an image from the recording medium.

13. The electronic device according to claim 12,
wherein the power consuming device is any one of a scanner unit, an inkjet head, and a cutter unit, each of the scanner unit, the inkjet head and the cutter unit comprising a CPU and a storage.

14. The electronic device according to claim 12,
wherein the power consuming device is any one of a maintenance unit, a conveying unit, a roll paper unit, and an ADF, each of the maintenance unit, the conveying unit, the roll paper unit, and the ADF comprising a storage.

15. The electronic device according to claim 12,
wherein the power consuming device is any one of a cutter unit and an option tray, each of the cutter unit and the option tray comprising neither a CPU nor a storage.

16. The electronic device according to claim 12,
wherein the power consuming device is an external device comprising a CPU and a memory, and is any one of a personal computer, a tablet personal computer, a smartphone, and a communication device.

17. An electronic device for receiving supply of power from a power supply device, the electronic device comprising:
a controller; and
a connection interface configured to be connected to a power consuming device,
wherein in a state of receiving supply of first power from the power supply device in accordance with a USB PD standard, the controller is configured to acquire a supply condition of power required by the power consuming device connected to the connection interface, and perform power negotiation for requesting the power supply device to supply second power based on the acquired supply condition.

18. An electronic device for receiving supply of power from a power supply device, the electronic device comprising:
a controller; and
a connection interface configured to be connected to a power consuming device,
wherein after changing from a state of not being connected to the power supply device to a state of being connected to the power supply device, the electronic device is configured to receive supply of first power from the power supply device in accordance with a standard related to supply of power through a communication cable, and the controller is configured to start operating using the first power, and
wherein after starting operating, the controller is configured to acquire a supply condition of power required by the power consuming device connected to the connection interface, and request the power supply device to supply second power larger than the first power based on the acquired supply condition.
